(19) United States
(12) Patent Application Publication
(10) Pub. No.: US 2021/0011324 A1
(43) Pub. Date: Jan. 14, 2021

(54) DISPLAY MODULE AND DISPLAY DEVICE

(71) Applicant: TCL CHINA STAR OPTOELECTRONICS TECHNOLOGY CO., LTD., Shenzhen, Guangdong (CN)

(72) Inventor: Qingyong ZHU, Shenzhen, Guangdong (CN)

(21) Appl. No.: 16/618,802

(22) PCT Filed: Nov. 12, 2019
(86) PCT No.: PCT/CN2019/117521

§ 371 Date: Dec. 3, 2019

(30) Foreign Application Priority Data
Mar. 9, 2019 (CN) 201910829393

(51) Int. Cl. G02F 1/1345; G02F 1/1339

(52) U.S. Cl. CPC G02F 1/13458; G02F 1/13452; G02F 1/1339

(57) ABSTRACT

A display module and a display device are provided. The display module includes a binding area. The binding area is provided with a first substrate and at least one first terminal. The first terminal extends from one side close to the display area to one side away from the display area, and is in contact with a first lateral surface of the display module. An area of a first cross-section of the first terminal close to the first lateral surface is larger than an area of a second cross-section of the first terminal away from the first lateral surface.

### FIELD OF INVENTION

The present disclosure relates to the field of displays, and particularly relates to a display module and a display device.

### BACKGROUND OF INVENTION

In current display apparatuses, both the binding between an integrated circuit board and a substrate, and the binding between a printed circuit board and the substrate are achieved by an anisotropic conductive film (ACF). The integrated circuit board and the printed circuit board are electrically connected to the corresponding circuits on the substrate respectively by utilizing the characteristics of the ACF vertical electrical conduction (z direction) and lateral insulation (x and y directions).

With the development of display apparatuses, the user's demand for narrow frames has gradually increased. In the design of existing narrow frames, a binding area of driving IC is often disposed on a lateral surface of a display panel. Since the printed circuit board (PCB) is disposed on a lateral edge of the display panel, an area connecting the printed circuit board with a data output terminal in the display panel is small, and the impedance is great, resulting in abnormal signal transmission.

Therefore, there is a need for a display apparatus to solve the above technical problems.

### SUMMARY OF INVENTION

The present disclosure provides a display module and a display device to solve the technical problems of abnormal data transmission of the existing display panel.

To solve the above problems, the present disclosure provides the technical solutions as follow.

The present application provides a display module comprising a display area and a non-display area located at a periphery of the display area. The non-display area comprises a sealing area close to the display area and a binding area away from one side of the display area.

The binding area is provided with a first substrate and at least one first terminal located on the first substrate. The first terminal extends from one side close to the display area to one side away from the display area, and is in contact with a first lateral surface of the display module.

An area of a first cross-section of the first terminal close to the first lateral surface in a first cross-sectional plane is larger than an area of a second cross-section of the first terminal away from the first lateral surface in a second cross-sectional plane.

The first cross-sectional plane and the second cross-sectional plane are parallel to the first lateral surface.

In the display module of the present application, the binding area comprises a first area close to the display area and a second area away from the display area.

In a direction from the first substrate to the first terminal, a height of the first terminal located in the first area is less than a height of the first terminal located in the second area.

In the display module of the present application, a thickness of the first terminal located in the first area is less than a thickness of the first terminal located in the second area.

In the display module of the present application, a shape of a third cross-section of the first terminal located in the second area in a third cross-sectional plane comprises at least one of a trapezoid, a rectangle, a square, and a triangle.

The third cross-sectional plane is perpendicular to the first lateral surface and the first substrate.

In the display module of the present application, the binding area is further provided with a first protrusion located between the first substrate and the first terminal, and the first protrusion is disposed close to the first lateral surface.

an included angle between the first terminal located on the first protrusion and disposed close to the first lateral surface and the first lateral surface is a, and 30°≤a≤70°.

In the display module of the present application, in the second cross-sectional plane, a cross-sectional shape of the first protrusion comprises at least one of a trapezoid, a rectangle, a square, and a triangle.

In the display module of the present application, the sealing area has an overlapping portion with the binding area.

The sealing area is provided with a sealant, and the sealant covers the first terminal located in the overlapping portion.

In the display module of the present application, the binding area is located in the sealing area.

The sealant covers the first terminal in the binding area.

In the display module of the present application, the display module further comprises a second substrate disposed opposite to and parallel to the first substrate, and a positive projection of the second substrate on the first substrate coincides with the first substrate.

The first substrate is one of an array substrate and a color film substrate, and the second substrate is the other of the array substrate and the color film substrate.

The present application further provides a display device comprising a display module. The display module comprises a display area and a non-display area located at a periphery of the display area, and the non-display area comprises a sealing area close to the display area and a binding area away from one side of the display area.

The binding area is provided with a first substrate and at least one first terminal located on the first substrate. The first terminal extends from one side close to the display area to one side away from the display area, and is in contact with a first lateral surface of the display module.

An area of a first cross-section of the first terminal close to the first lateral surface in a first cross-sectional plane is larger than an area of a second cross-section of the first terminal away from the first lateral surface in a second cross-sectional plane.

The first cross-sectional plane and the second cross-sectional plane are parallel to the first lateral surface.

In the display device of the present application, the binding area comprises a first area close to the display area and a second area away from the display area.

In a direction from the first substrate to the first terminal, a height of the first terminal located in the first area is less than a height of the first terminal located in the second area.

In the display device of the present application, a thickness of the first terminal located in the first area is less than a thickness of the first terminal located in the second area.

In the display device of the present application, a shape of a third cross-section of the first terminal located in the second area in a third cross-sectional plane comprises at least one of a trapezoid, a rectangle, a square, and a triangle.

The third cross-sectional plane is perpendicular to the first lateral surface and the first substrate.

In the display device of the present application, the binding area is further provided with a first protrusion located between the first substrate and the first terminal, and the first protrusion is disposed close to the first lateral surface.

An included angle between the first terminal located on the first protrusion and disposed close to the first lateral surface and the first lateral surface is a, and 30°≤a≤70°.

In the display device of the present application, in the second cross-sectional plane, a cross-sectional shape of the first protrusion comprises at least one of a trapezoid, a rectangle, a square, and a triangle.

In the display device of the present application, the sealing area has an overlapping portion with the binding area.

The sealing area is provided with a sealant, and the sealant covers the first terminal located in the overlapping portion.

In the display device of the present application, the binding area is located in the sealing area.

The sealant covers the first terminal in the binding area.

In the display device of the present application, the display module further comprises a second substrate disposed opposite to and parallel to the first substrate, and a positive projection of the second substrate on the first substrate coincides with the first substrate.

The first substrate is one of an array substrate and a color film substrate, and the second substrate is the other of the array substrate and the color film substrate.

The beneficial effects are as follows. In the present application, by making the area of the cross-section of the terminal close to the first lateral surface larger than the area of the first cross-section of the terminal away from the first lateral surface, the contact area of the terminal in the binding area with the printed circuit board is increased, and the contact impedance between the terminal and the printed circuit board is reduced, thereby solving the technical problem of abnormal data signal transmission.

### DESCRIPTION OF DRAWINGS

In order to clearly illustrate the technical solutions in the embodiments of the present disclosure or the prior art, the following briefly introduces the accompanying drawings used in the embodiments and the prior art. Obviously, the drawings in the following description merely show some of the embodiments of the present disclosure. As regards one of ordinary skill in the art, other drawings may be obtained in accordance with these accompanying drawings without making creative efforts.

FIG. 1 is a top view of a display module of the present application.

FIG. 2 is a first cross-sectional view of the display module of the present application.

FIG. 3 is a second cross-sectional view of the display module of the present application.

FIG. 4 is a diagram of a method of a local area of FIG. 3 of the present application.

FIG. 5 is a third cross-sectional view of the display module of the present application.

### DETAILED DESCRIPTION OF PREFERRED EMBODIMENTS

The following description of every embodiment, with reference to the accompanying drawings, is used to exemplify a specific embodiment which may be carried out in the present disclosure. Directional terms mentioned in the present disclosure, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present disclosure.

In the design of the existing narrow frame, the binding area of driving IC is often disposed on a lateral surface of a display panel. Since the printed circuit board (PCB) is disposed on a lateral edge of the display panel, an area connecting the printed circuit board and a data output terminal in the display panel is small, and the impedance is large, resulting in abnormal signal transmission. Based on the technical problems, the present application provides a display module to solve the above technical problems.

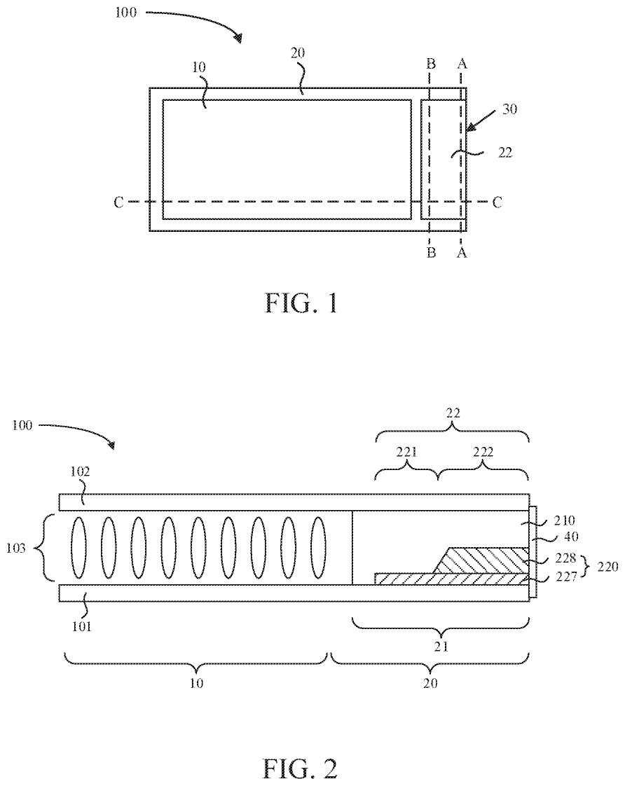

Referring to FIG. 1 to FIG. 5, a display module 100 comprises a display area 10 and a non-display area 20 located at a periphery of the display area 10. The non-display area 20 comprises a sealing area 21 close to the display area 10 and a binding area 22 away from one side of the display area 10.

The binding area 22 is provided with a first substrate 101 and at least one first terminal 220 located on the first substrate 101. The first terminal 220 extends from one side close to the display area 10 to one side away from the display area 10, and is in contact with a first lateral surface 30 of the display module 100.

In the present embodiment, a printed circuit board 40 is also formed on the first lateral surface 30. A driving chip (not shown) is formed on the printed circuit board 40, and the driving chip is bound onto the printed circuit board 40 by the corresponding anisotropic conductive adhesive.

An area of a first cross-section of the first terminal 220 close to the first lateral surface 30 in a first cross-sectional plane AA is larger than an area of a second cross-section of the first terminal 220 away from the first lateral surface 30 in a second cross-sectional plane BB.

In the present embodiment, the first cross-sectional plane AA and the second cross-sectional plane BB are parallel to the first lateral surface 30.

In the present embodiment, the plane in which the first direction X and the second direction Y are located may be perpendicular to the first lateral surface 30.

In the present embodiment, the first cross-sectional plane AA is parallel to the first lateral surface 30.

In the present application, by making the area of the cross-section of the terminal close to the first lateral surface 30 larger than the area of the cross-section of the terminal away from the first lateral surface 30, the contact area of the terminal in the binding area 22 with the printed circuit board 40 is increased, and the contact impedance between the terminal and the printed circuit board 40 is reduced, thereby solving the technical problem of abnormal data signal transmission.

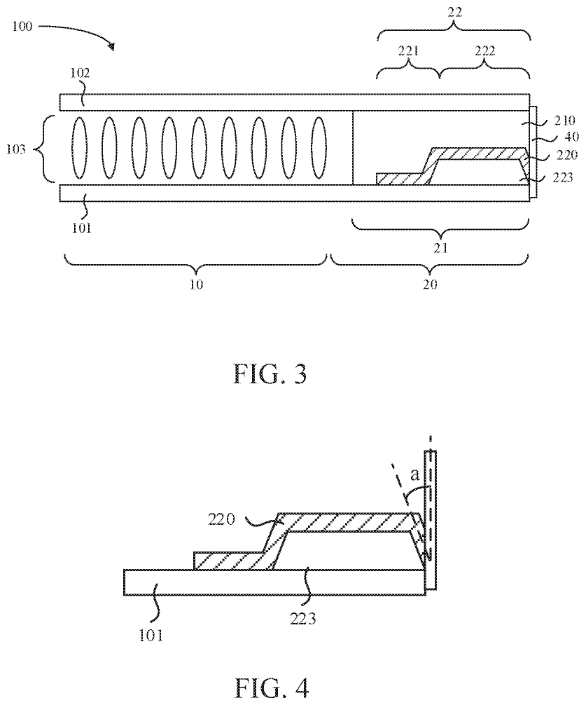

Referring to FIG. 2 to FIG. 3, the binding area 22 comprises a first area 221 close to the display area 10 and a second area 222 away from the display area 10.

In an embodiment, in a direction from the first substrate 101 to the first terminal 220, a height of the first terminal 220 located in the first area 221 is less than a height of the first terminal 220 located in the second area 222.

Referring to FIG. 2, a thickness of the first terminal 220 located in the first area 221 is less than a thickness of the first terminal 220 located in the second area 222.

In the present embodiment, the first terminal 220 at least comprises a first metal layer 227 and a second metal layer 228, wherein the second metal layer 228 and the metal layer thereon are located in the second area 222.

In the present embodiment, the first terminal 220 may be formed in the same photomask process as the metal layer in the first substrate 101. For example, when the first substrate 101 is an array substrate, the first metal layer 227 may be formed in the same photomask process as a gate layer, and the second metal layer 228 may be formed in the same photomask process as a source and drain layer. When the first terminal 220 comprises three or more metal layers, it may be formed by a light shielding layer or a pixel electrode layer, and the like, in the first substrate 101, which is not specifically limited in the present application.

Alternatively, the first terminal 220 may be formed by a single metal deposition process, or sputtering process, and the like, and then by a patterning process of a multi-section mask to form the first area 221 and the second area with different thicknesses.

In the present embodiment, a shape of a third cross-section of the first terminal 220 located in the second area 222 in a third cross-sectional plane CC may comprise at least one of a trapezoid, a rectangle, a square, or and a triangle. Referring to FIG. 2, the shape of the cross-section of the first terminal 220 located in the second area 222 in the present embodiment is a trapezoid, and a surface close to the first lateral surface 30 is parallel to the first lateral surface 30.

In the present embodiment, the third cross-sectional plane CC is perpendicular to the first lateral surface 30 and the first substrate 101.

In the present embodiment, the first terminal 220 with different thicknesses is formed in the binding area 22 by different processes, wherein the thickness of the first terminal 220 close to the first lateral surface 30 is larger than the thickness of the first terminal 220 away from the first lateral surface 30, thereby increasing the contact area of the first terminal 220 with the printed circuit board 40, reducing the contact impedance between the terminal and the printed circuit board 40, and solving the technical problem of abnormal data signal transmission.

Referring to FIG. 3, the binding area 22 is further provided with a first protrusion 223 located between the first substrate 101 and the first terminal 220, and the first protrusion 223 is disposed close to the first lateral surface 30.

In the present embodiment, the first protrusion 223 may be located in the second area 222.

Compared with FIG. 2, in the present embodiment, a protrusion having a certain slope is formed in a region close to the first lateral surface 30. When the first terminal 220 is formed in the binding area 22, according to the corresponding deposition or sputtering process, the first terminal 220 is formed on the first protrusion 223 corresponding to the slope. The first terminal 220 of the present embodiment may further comprise a first metal layer 227, or both a first metal layer 227 and a second metal layer 228, which are not limited herein.

Referring to FIG. 4, an included angle between the first terminal 220 located on the first protrusion 223 and disposed close to the first lateral surface 30 and the first lateral surface 30 is a, and 30°≤a≤70°.

In the present embodiment, a cross-sectional shape of the first protrusion 223 in the third cross-sectional plane CC may comprise at least one of a trapezoid, a rectangle, a square, and a triangle. Referring to FIG. 3, the cross-sectional shape of the first protrusion 223 in the third cross-sectional plane CC may be a trapezoid in the present embodiment. The first terminal 220 having a certain slope is formed according to a bevel of the trapezoid, and an area of the first terminal 220 in contact with the first lateral surface 30 is larger than an area of the cross-section of the first terminal 220 located in the first area 221.

In the present embodiment, a material of the first protrusion 223 may be an inorganic material or an organic material, which is not limited in the present application. The first protrusion 223 may be formed in the same photomask process as an inorganic layer or an organic layer in the first substrate 101, such as a planarization layer or a pixel define layer.

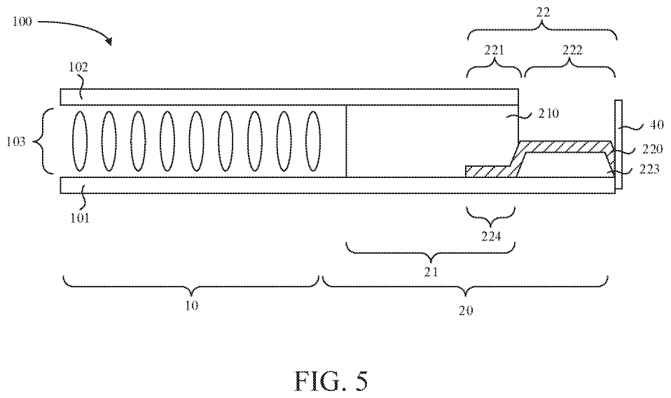

Referring to FIG. 5, the sealing area 21 has an overlapping portion 224 with the binding area 22.

The sealing area 21 is provided with a sealant 210, and the sealant 210 covers the first terminal 220 located in the overlapping portion 224.

The binding area 22 is disposed separately from the sealing area 21 in the prior art, while a portion of the binding area 22 is disposed in the sealing area 21 in the present application to reduce the space occupied by the frame of the display module 100. Thus, the design of the narrow frame is achieved.

Referring to FIG. 2 to FIG. 3, the binding area 22 may be located in the sealing area 21.

The present embodiment is the same as or similar to FIG. 5, and the difference therebetween is as follows.

The sealant covers the first terminal 220 in the binding area 22.

In the present embodiment, by completely disposing the binding area 22 in the sealing area 21, the sealant 210 covers the first terminal 220 in the binding area 22. The present embodiment ensures the design of the narrow frame of the display module 100. Further, the existence of the sealant has a good seal on the first terminal 220, and blocks water and oxygen in the air damaging to metal terminal in the binding area 22.

Referring to FIG. 2 to FIG. 3, the display module 100 further comprises a second substrate 102 disposed opposite to and parallel to the first substrate 101, and a liquid crystal layer 103 located between the first substrate 101 and the second substrate 102.

In an embodiment, a positive projection of the second substrate 102 on the first substrate 101 coincides with the first substrate 101.

In an embodiment, the first substrate 101 is one of an array substrate and a color film substrate, and the second substrate 102 is the other of the array substrate and the color film substrate.

In the prior art, in order to dispose the binding area 22, an area of the array substrate is generally larger than an area of the color film substrate to reserve the area of the binding area 22. In the present embodiment, by disposing the binding area 22 in the sealing area 21, the first substrate 101 and the second substrate 102 may be disposed to have the same area.

In addition, when cutting a display panel motherboard, the color film substrate is generally cut according to a first cutting line, and then the array substrate is cut according to a second cutting line. In the present application, the first substrate 101 and the second substrate 102 have the same area. Thus, only cutting the display panel by the first cutting line is needed when cutting, which simplifies the process and improves the production efficiency.

The present disclosure further provides a display device, and the display device comprises the above display module. The working principle of the display device may refer to the display module, and the details are not described herein. It can be understood that the electronic device comprises, but is not limited to, a mobile phone, a tablet computer, a computer display, a game machine, a television, a display screen, a wearable device, and other living appliances or household appliances having display functions.

The present disclosure provides a display module and a display device. The display module comprises a binding area. The binding area is provided with a first substrate and at least one first terminal located on the first substrate. The first terminal extends from one side close to the display area to one side away from the display area, and is in contact with a first lateral surface of the display module. An area of a first cross-section of the first terminal close to the first lateral surface in a first cross-sectional plane is larger than an area of a second cross-section of the first terminal away from the first lateral surface in a second cross-sectional plane. In the present application, by making the area of the cross-section of the terminal close to the first lateral surface larger than the area of the first cross-section of the terminal away from the first lateral surface, the contact area of the terminal in the binding area with the printed circuit board is increased, and the contact impedance between the terminal and the printed circuit board is reduced, thereby solving the technical problem of abnormal data signal transmission.

In summary, although the preferable embodiments of the present disclosure have been disclosed above, the embodiments are not intended to limit the present disclosure. A person of ordinary skill in the art, without departing from the spirit and scope of the present disclosure, can make various modifications and variations. Therefore, the scope of the disclosure is defined in the claims.

What is claimed is:

1. A display module, comprising a display area and a non-display area located at a periphery of the display area, the non-display area comprising a sealing area close to the display area and a binding area away from one side of the display area;
the binding area provided with a first substrate and at least one first terminal located on the first substrate, wherein the first terminal extends from one side close to the display area to one side away from the display area, and is in contact with a first lateral surface of the display module;
an area of a first cross-section of the first terminal close to the first lateral surface in a first cross-sectional plane is larger than an area of a second cross-section of the first terminal away from the first lateral surface in a second cross-sectional plane;
wherein the first cross-sectional plane and the second cross-sectional plane are parallel to the first lateral surface.

2. The display module according to claim 1, wherein the binding area comprises a first area close to the display area and a second area away from the display area; and
in a direction from the first substrate to the first terminal, a height of the first terminal located in the first area is less than a height of the first terminal located in the second area.

3. The display module according to claim 2, wherein a thickness of the first terminal located in the first area is less than a thickness of the first terminal located in the second area.

4. The display module according to claim 3, wherein a shape of a third cross-section of the first terminal located in the second area in a third cross-sectional plane comprises at least one of a trapezoid, a rectangle, a square, and a triangle;
wherein the third cross-sectional plane is perpendicular to the first lateral surface and the first substrate.

5. The display module according to claim 2, wherein the binding area is further provided with a first protrusion located between the first substrate and the first terminal, and the first protrusion is disposed close to the first lateral surface;
wherein an included angle between the first terminal located on the first protrusion and disposed close to the first lateral surface and the first lateral surface is a, and 30°≤a≤70°.

6. The display module according to claim 5, wherein in the second cross-sectional plane, a cross-sectional shape of the first protrusion comprises at least one of a trapezoid, a rectangle, a square, and a triangle.

7. The display module according to claim 1, wherein the sealing area has an overlapping portion with the binding area; and
the sealing area is provided with a sealant, and the sealant covers the first terminal located in the overlapping portion.

8. The display module according to claim 7, wherein the binding area is located in the sealing area; and
the sealant covers the first terminal in the binding area.

9. The display module according to claim 1, wherein the display module further comprises a second substrate disposed opposite to and parallel to the first substrate, and a positive projection of the second substrate on the first substrate coincides with the first substrate;
wherein the first substrate is one of an array substrate and a color film substrate, and the second substrate is the other of the array substrate and the color film substrate.

10. A display device, comprising a display module, the display module comprising a display area and a non-display area located at a periphery of the display area, and the non-display area comprising a sealing area close to the display area and a binding area away from one side of the display area;
the binding area provided with a first substrate and at least one first terminal located on the first substrate, wherein the first terminal extends from one side close to the display area to one side away from the display area, and is in contact with a first lateral surface of the display module;
an area of a first cross-section of the first terminal close to the first lateral surface in a first cross-sectional plane is larger than an area of a second cross-section of the first terminal away from the first lateral surface in a second cross-sectional plane;
wherein the first cross-sectional plane and the second cross-sectional plane are parallel to the first lateral surface.

11. The display device according to claim 10, wherein the binding area comprises a first area close to the display area and a second area away from the display area; and
in a direction from the first substrate to the first terminal, a height of the first terminal located in the first area is less than a height of the first terminal located in the second area.

12. The display device according to claim 11, wherein a thickness of the first terminal located in the first area is less than a thickness of the first terminal located in the second area.

13. The display device according to claim 12, wherein a shape of a third cross-section of the first terminal located in the second area in a third cross-sectional plane comprises at least one of a trapezoid, a rectangle, a square, and a triangle;
wherein the third cross-sectional plane is perpendicular to the first lateral surface and the first substrate.

14. The display device according to claim 11, wherein the binding area is further provided with a first protrusion located between the first substrate and the first terminal, and the first protrusion is disposed close to the first lateral surface;
wherein an included angle between the first terminal located on the first protrusion and disposed close to the first lateral surface and the first lateral surface is a, and 30°≤a≤70°.

15. The display device according to claim 14, wherein in the second cross-sectional plane, a cross-sectional shape of the first protrusion comprises at least one of a trapezoid, a rectangle, a square, and a triangle.

16. The display device according to claim 10, wherein the sealing area has an overlapping portion with the binding area; and
the sealing area is provided with a sealant, and the sealant covers the first terminal located in the overlapping portion.

17. The display device according to claim 16, wherein the binding area is located in the sealing area; and
the sealant covers the first terminal in the binding area.

18. The display device according to claim 10, wherein the display module further comprises a second substrate disposed opposite to and parallel to the first substrate, and a positive projection of the second substrate on the first substrate coincides with the first substrate;
wherein the first substrate is one of an array substrate and a color film substrate, and the second substrate is the other of the array substrate and the color film substrate.
